(19) United States
(12) Patent Application Publication
(10) Pub. No.: US 2024/0338267 A1
(43) Pub. Date: Oct. 10, 2024

(54) SYSTEMS AND METHODS FOR PACKAGE-TO-PACKAGE COMMUNICATION

(71) Applicant: Meta Platforms Technologies, LLC, Menlo Park, CA (US)

(72) Inventors: Jumnit Hong, Portland, OR (US); Amnon Harpak, Tel Aviv (IL); Orit Lev, Zikhron Ya'akov (IL); Ram Weiss, Zoran (IL)

(21) Appl. No.: 18/626,260

(22) Filed: Apr. 3, 2024

Related U.S. Application Data
(60) Provisional application No. 63/494,009, filed on Apr. 4, 2023.

(51) Int. Cl. G06F 9/54

(52) U.S. Cl. CPC G06F 9/546

(57) ABSTRACT

The disclosed computer-implemented method may include coalescing and queueing, by an integrated circuit, messages in multiple message queues based on a latency tolerance level for the message. Additionally, the disclosed computer-implemented method may include transitioning, by the integrated circuit, a data transfer link to an active state based on the latency tolerance level for the message queue. This method may optimize power for the data transfer link by keeping it in a low power state for as long as possible. Various other methods, systems, and computer-readable media are also disclosed.

### CROSS REFERENCE TO RELATED APPLICATION

This application claims the benefit of U.S. Provisional Application No. 63/494,009 filed Apr. 4, 2023, the disclosure of which is incorporated, in its entirety, by this reference.

### BRIEF DESCRIPTION OF DRAWINGS

FIG. 1 is a flow diagram illustrating an example method for package-to-package communication in accordance with the present disclosure.

FIG. 2 is a block diagram illustrating an example package-to-package communication in accordance with the present disclosure.

FIG. 3 is a block diagram illustrating an example inter-process communication stack in accordance with the present disclosure.

FIG. 4 is a block diagram illustrating an example virtual wire in accordance with the present disclosure.

FIG. 5 is a block diagram illustrating an example time synchronization through virtual wire in accordance with the present disclosure.

FIG. 6 is a block diagram illustrating an example general purpose input/output control through virtual wire in accordance with the present disclosure.

FIG. 7 is a block diagram illustrating an example package-to-package communication duty cycle in accordance with the present disclosure.

FIG. 8 is a graphical illustration depicting an example power cost of transitioning a package-to-package communication connection in accordance with the present disclosure.

FIG. 9 is a graphical illustration depicting an example of duty cycle period adapted to message traffic latency tolerance level setting in accordance with the present disclosure.

FIG. 10 is an illustration of exemplary augmented-reality glasses that may be used in connection with embodiments of this disclosure.

FIG. 11 is an illustration of an exemplary virtual-reality headset that may be used in connection with embodiments of this disclosure.

### DETAILED DESCRIPTION OF EXEMPLARY EMBODIMENTS

The present disclosure is generally directed to systems and methods for package-to-package communication. For example, by queueing a message in a message queue based on a latency tolerance level for the message, transitioning a data transfer link to an active state based on a presence of the message in the message queue and the latency tolerance level for the message, and transferring the message over the data transfer link while the data transfer link is in the active state, the disclosed systems and methods may duty cycle a link layer of a communication protocol with a frequency that satisfies the latency tolerance level. In this way, the disclosed systems and methods may achieve reduced power consumption and utilize a minimum number of wires to provide a low latency communications channel between packages.

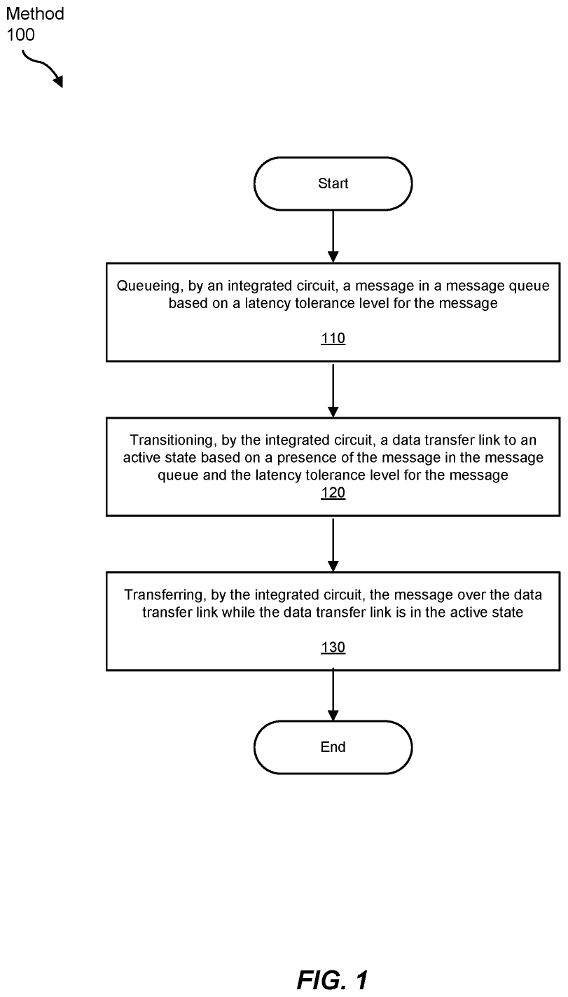

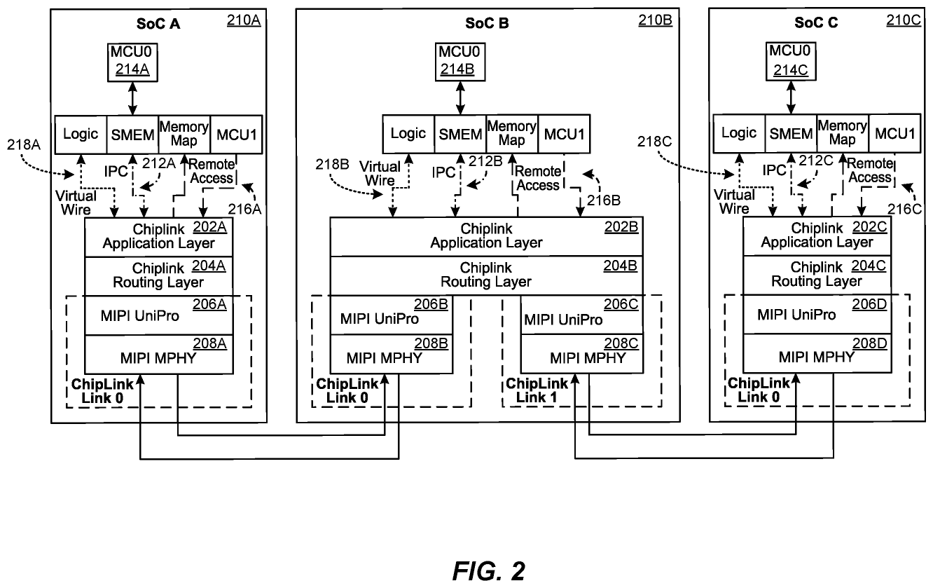

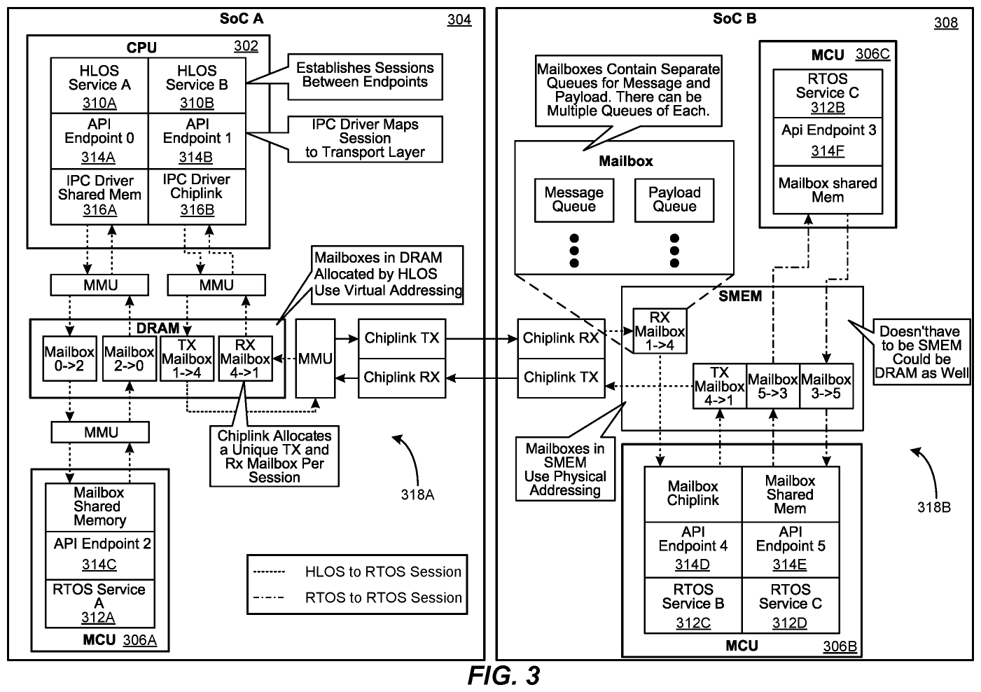

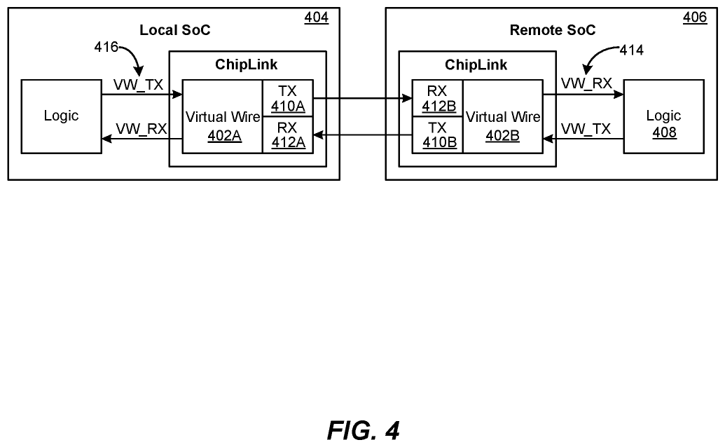

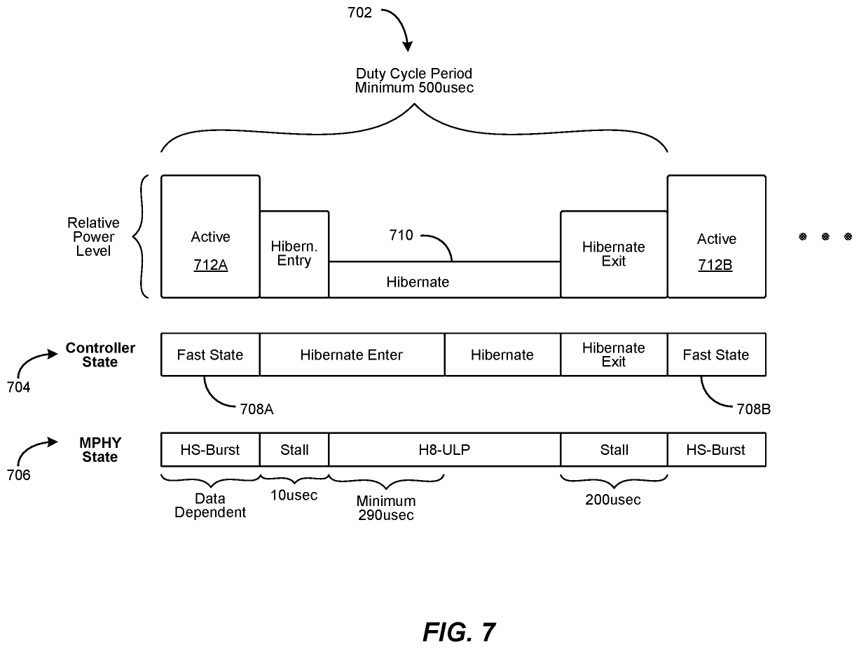

The following will provide, with reference to FIG. 1, detailed descriptions of example methods for package-to-package communication. An example package-to-package communication will be described herein with reference to FIG. 2. An example inter-process communication stack will be described herein with reference to FIG. 3. An example virtual wire will be described herein with reference to FIGS. 4-6. An example package-to-package communication duty cycle will be described herein with reference to FIGS. 7-9.

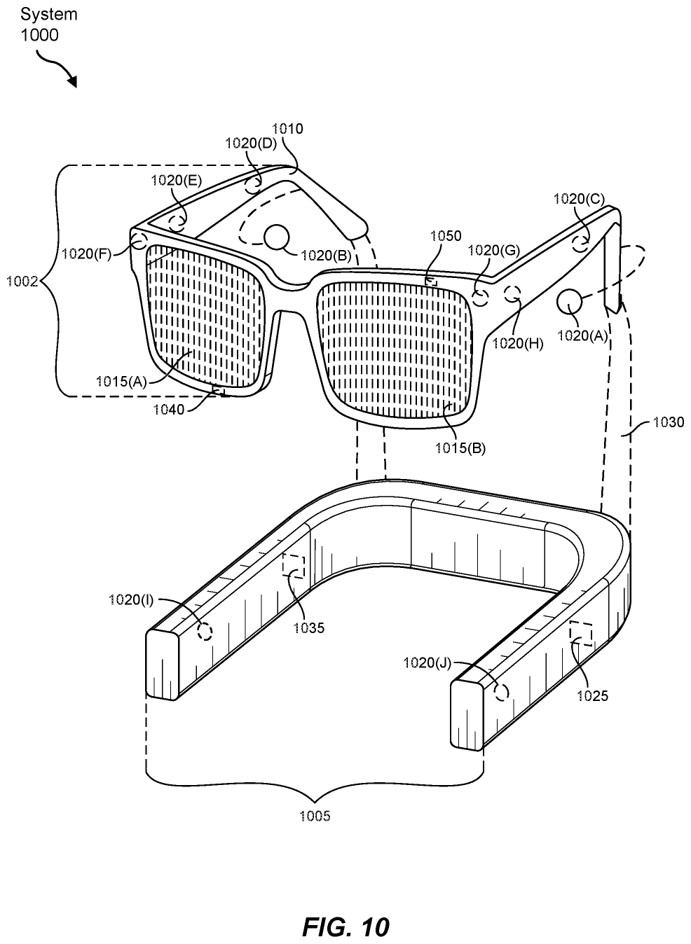

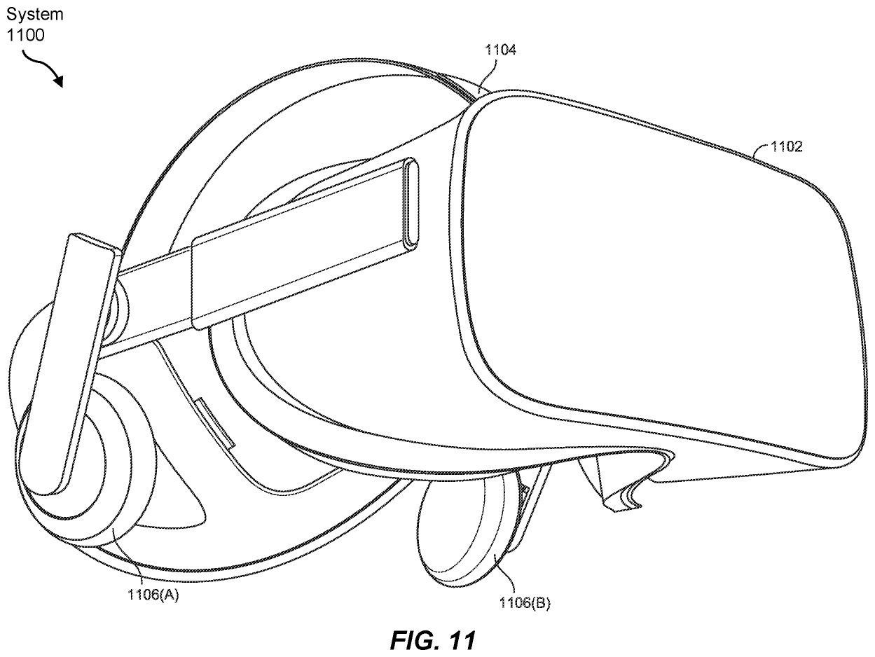

Because many of the embodiments described herein may be used with substantially any type of virtual or augmented reality system, various components of such systems will be described with reference to FIGS. 10 and 11. These figures will introduce the various devices and procedures used to provide virtual and/or augmented reality experiences to users.

Referring to FIG. 1, a computer-implemented method 100 for package-to-package communication may be performed by an integrated circuit. As shown in FIG. 1, the integrated circuit may, at step 110, queue a message. For example, at step 110 the integrated circuit may queue a message in a message queue based on a latency tolerance level for the message.

The term “integrated circuit” may generally refer to an assembly of electronic components. For example, and without limitation, an integrated circuit may correspond to an assembly of electronic components in which hundreds to millions of transistors, resistors, and capacitors are interconnected and built up on a thin substrate of semiconductor material (usually silicon) to form a small chip or wafer.

The term “queue” may generally refer to a collection of entities. For example, and without limitation, a queue may refer to a collection of entities that are maintained in a sequence and can be modified by the addition of entities at one end of the sequence and the removal of entities from the other end of the sequence. Queue may also refer to the act of adding an entity to a queue and/or arranging one or more entities in a queue.

The term “message” may generally refer to a discrete unit of information. For example, and without limitation, a message may be a discrete unit of communication intended by the source for consumption by some recipient or group of recipients.

The term “latency” may generally refer to a delay. For example, and without limitation, latency may refer to a combined delay between an input or command and a desired output. In this context, a latency tolerance level may refer to an amount of latency that a message or message type can tolerate.

The integrated circuit may perform step 110 in a variety of ways. For example, the integrated circuit may, at step 110, determine the latency tolerance level for the message by determining a message type of the message and identifying a predefined latency tolerance level associated with the message type. In another example, the integrated circuit may, at step 110, queue a first message having a first latency tolerance level in a first message queue dedicated to messages having the first latency tolerance level and queue a second message having a second latency tolerance level in a second message queue that is dedicated to messages having the second latency tolerance level.

As shown in FIG. 1, the integrated circuit may, at step 120, transition a data transfer link. For example, at step 110 the integrated circuit may transition a data transfer link to an active state based on a presence of the message in the message queue and the latency tolerance level for the message.

The term “transition” may generally refer to the process or a period of changing from one state or condition to another. For example, and without limitation, transition may refer to causing a thing to undergo a process or period of transition.

The term “data transfer link” may generally refer to a connection. For example, and without limitation, a data transfer link may correspond to a connection of one location to another in order to transmit and receive digital information.

The term “active state” may generally refer to powered on. For example, and without limitation, an active state may refer to a link that is powered on in order to transmit and/or receive messages.

The integrated circuit may perform step 120 in a variety of ways. For example, at step 120, the integrated circuit may observe, at a first point in time, absence of at least one message having a first latency tolerance level. The integrated circuit may also wait, in response to the observation, until a second point in time to observe presence of at least one message having a second latency tolerance level. For example, the first latency tolerance level may be longer than the second latency tolerance level. In this example, the transition of the data transfer link to the active state may occur in response to the presence of the message having the second (e.g., shorter) latency tolerance level. In another example, the first latency tolerance level may be shorter than the second latency tolerance level. In this example, the transition of the data transfer link to the active state may occur in response to the absence of any message (e.g., empty message queue dedicated for shorter latency tolerance level messages) having the first (e.g., shorter) latency tolerance level and the presence of the message (e.g., non-empty message queue dedicated for longer latency tolerance level messages) having the second (e.g., longer) latency tolerance level.

As shown in FIG. 1, the integrated circuit may, at step 130, transfer a message. For example, at step 130 the integrated circuit may transfer the message over the data transfer link while the data transfer link is in the active state.

The term “transfer” may generally refer to a process of copying data. For example, and without limitation, a transfer may refer to the process of copying data from one location to another.

The integrated circuit may perform step 130 in a variety of ways. For example, at step 130, the integrated circuit may transfer a plurality of messages having different latency tolerance levels over the data transfer link (e.g., based on the shortest latency tolerance level). In another example, the message may be generated by a first system on a chip (SoC) and may be transferred (e.g., by the integrated circuit) to a second SoC at step 130. In another example, the integrated circuit may, at step 130, utilize a virtual wire comprising a physical on-die wire to virtual wire message interface to perform two-way transfer of messages between a first system on a chip (SoC) and a second SoC.

Method 100 serves as an example method for identifying, by an integrated circuit and at an application layer of a communication protocol, a latency tolerance level (e.g., at step 110) and duty cycling, by the integrated circuit, a link layer of the communication protocol with a frequency that satisfies the latency tolerance level (e.g., at steps 120 and/or 130). For example, determining the latency tolerance level (e.g., at step 110) may include determining a message type of a message and identifying a predefined latency tolerance level associated with the message type. Additionally, duty cycling the link layer (e.g., at step 120) may include transitioning a data transfer link to an active state based at least in part on the latency tolerance level. Alternatively or additionally, duty cycling the link layer (e.g., at step 130) may include transitioning a data transfer link to a low-power state following transfer of messages by the link layer. Also, the link layer may utilize a virtual wire comprising a physical wire to virtual wire message interface to perform two-way transfer of messages between a first system on a chip (SoC) and a second SoC. Finally, the link layer may transfer (e.g., at step 130) all enqueued messages while in an active state regardless of latency tolerance levels of the enqueued messages.

FIGS. 2-9 detail an example package-to-package communication protocol (hereinafter referred to as Chip Link) implementing the disclosed systems and methods to achieve numerous benefits. For example, some products may be constrained, from an Industrial Design (ID) perspective, by the limited area that is available on the headsets or glasses and thermal constraints. Therefore, the computing chores may be split among multiple chips. These chips may benefit from being able to communicate with each other as efficiently as possible, using low-power and a minimum number of wires to provide a low latency communications channel between chips.

Compute options (e.g., for AR and/or VR devices) may be split, and a general purpose communications link may be implemented between chips. The partitioning of chips may be performed such that a majority of processing is performed on the same chip that is used to collect sensor data. This partitioning may minimize the amount of data that needs to be transmitted between chips.

General purpose communications may refer to processing of various types of computing tasks. One such task may correspond to rendering surfaces, 3D/2D assets, input commands, etc. Another such process may correspond to processing image sensor data, IMU data, audio data, etc. Yet another such process may correspond to exchanging control messages. Still another such process may correspond to processing eye pose, head pose, and hand pose data. A further such process may correspond to coordinating the exchange of audio data that is captured on one chip and processed by another chip.

In SoCs, a method of inter-SoC communication may be built upon an interprocess communication (IPC) architecture that may be scalable and operate over many different transports (e.g., wireless, I3C, PCIe, USB, etc). This IPC architecture may serve as a backbone for how High-Level OS's (HLOS) communicate with services running on Real-Time OSes (RTOS). For Inter-SoC communications, intermediate MCUs may manage the transport of a message and/or payload as it traverses from one CPU/MCU to another MCU.

As shown in FIG. 2, Chip Link may implement the Inter Process Communications (IPC) transport (e.g., a mailbox application) at the Chip Link application layer 202A, 202B, and 202C and provide a connection for inter-SoC communications that connects directly with the IPC architecture. In this way, Chip Link may accomplish a package-to-package, high-speed IO communication link designed for connecting chips on a system board. The Chip Link stack may include a Chip Link application layer 202A, 202B, and 202C, a Chip Link routing layer 204A, 204B, and 204C, a MIPI UniPro Link Layer 206A, 206B, 206C, and 206D, and/or a MIPI MPHY 208A, 208B, 208C, and 208D. The application layer 202A, 202B, and 202C may correspond to a main interface for HW, FW, and SW to send messages between SoCs 210A, 210B, and 210C and may provide three main applications.

As shown in FIG. 2, one of the main applications provided by the application layer 202A, 202B, and 202C may correspond to an inter-process communication (IPC) channel 212A, 212B, and 212C between CPUs and MCUs 214A, 214B, and 214C across a Chip Link connection. Another of these main applications may correspond to a remote access (RA) 216A, 216B, and 216C to allow initialization, configuration, and debug access to SoCs 210A, 210B, and 210C connected through Chip Link with direct memory access into a remote SoC's memory space. Yet another of these main applications may correspond to a virtual wire (VW) 218A, 218B, and 218C to allow hardware to communicate directly across Chip Link via single wires that are packetized across the Chip Link interface.

As shown in FIG. 2, the routing layer 204A, 204B, and 204C may enable routing of messages between SoCs 210A, 210B, and 210C without requiring any FW or SW intervention. It may also support daisy chain connections between SoCs 210A, 210B, and 210C to allow tunneling through SoCs that contain more than one Chip Link link. In this context, a Chip Link link may be a point-to-point connection between two chips and encapsulate the MIPI power controller 206A, 206B, 206C, and 206D, and MIPI MPHY 208A, 208B, 208C, and 208D layers. Multiple Chip Link links may map to a single Chip Link application layer and routing layer. This may provide a single view for local software to access remote MCUs.

The application layer may serve as a main interface that firmware and hardware uses to send transactions through Chip Link and may be customized for silicon usage. Chip Link may be split into four applications. One of these applications may correspond to Inter-Processor Communications (IPC) for FW to remote FW communications. Another of these applications may correspond to remote access for FW to remote HW communications. Yet another of these applications may correspond to a virtual wire for HW to remote HW communications. Still another of these applications may correspond to a direct Message Interface (DMI) to allow FW to directly send a message through the link layer. All of these applications may be independent of each other and may be implemented on different Cports on the MIPI UniPro controller with no ordering dependency. IPC and remote access may implement AXI as a system interconnect protocol. Inter-Processor Communications (IPC) may be used for MCU to MCU and CPU to MCU communication. Chip Link IPC may be an implementation of a transport layer.

The term “endpoint” may generally refer to a node. For example, and without limitation, an endpoint may correspond to a logical node in the communication network that may produce, consume, and/or forward messages with other endpoints. For example, a system microcontroller unit (SMCU) may host a “log event aggregator” endpoint, an “SLA manager” endpoint, and others.

The term “session” may generally refer to a communication link. For example, and without limitation, a session may correspond to a stateful, bidirectional communication link between two endpoints, whether connected directly or via intermediate hops. For example, each session instance may be associated with an appropriate transport instance to perform message exchange.

The term “mailbox” may generally refer to a shared data structure. For example, and without limitation, a mailbox may correspond to an abstract concept in which messages are exchanged through a shared data structure called a mailbox, and an idiom well suited to a variety of message passing scenarios.

As shown in FIG. 3, the IPC communication stack between CPU/MCU and MCU/MCU may be established with the IPC architecture and map to Chip Link. For example, HLOS service 310A and 310B (e.g., of CPU 302 of SoC 304) or RTOS service 312A, 312B, 312C, and 312D (e.g., of MCU 306A of SoC 304 and/or MCUs 306B and 306C of SoC 308) may establish a session between two endpoints through the IPC architecture API 314A-314F. Additionally, the IPC architecture API 314A-314F may call the transport layer (e.g., IPC driver 316A and 316B, mailbox application 318A and 318B) via the mailbox application interface to create a set of simplex mailbox transports.

In one example, each Chip Link session may have four mailboxes assigned: two for transmitting to a remote SoC and two for receiving from a peer SoC. Producer endpoints may also write messages into TX mailboxes and consumer endpoints may read messages from RX mailboxes. In this context, each CPU/MCU may be associated with a globally unique ID to identify that particular CPU/MCU. Multiple endpoints/sessions may also be established on the same CPU/MCU that shares the same mailbox. Each session that shares a CPU/MCU may have its own queue within a mailbox, and separate queues may be identified with separate channels.

In an example, a queue may be uniquely identified by SrcID/DestID/Channel which may be sent with each message header and used to route a message from a producer queue to consumer queue. Also, each mailbox may include separate message and payload queues. Additionally, there may be multiple message and payload queues within a single mailbox and/or a minimum of a single message queue within a mailbox. In the context of Chip Link, queues may be implemented as a ring buffer, and each ring buffer that Chip Link manages may be configurable and may be assigned as a message or payload queue.

In an example, producers may update a TX queue write pointer when pushing messages into the ring buffer, and Chip Link TX hardware may update a TX queue read pointer based on the messages that are sent. In another example, consumers may update the read pointer of the RX queue as messages are consumed and Chip Link RX hardware may update the RX queue write pointer as messages are pushed into the RX queue.

Mailboxes may be implemented in various ways. For example, mailboxes may be located in DRAM or SMEM (i.e., SRAM), but may still be visible to Chip Link and the producer or consumer. In another example, mailboxes in DRAM that are allocated by HLOS may use virtual addressing and Chip Link may access the mailbox through an MMU. In another example, mailboxes in DRAM that are carved out (e.g., not HLOS allocated) may be physically addressed. In a further example, mailboxes in SMEM may be physically addressed.

Referring to FIG. 4, the disclosed link layer may utilize a virtual wire 402A and 402B comprising a physical wire to virtual wire message interface that encodes the physical wire state into a message for transfer of messages between a first system on a chip (SoC) 404 and a second SoC 406. For example, virtual wire 402A and 402B may allow a local SoC 404 to toggle or pulse an on-die wire and have it propagate to a remote SoC's 406 logic 408. The usage of virtual wire 402A and 402B may be suited for synchronization, interrupts, or other asynchronous signals that are used between SoCs 404 and 406. Each virtual wire 402A and 402B may be configured to be toggle or pulse mode. In toggle mode, the current state of the wire may be sent from TX 410A and 410B to RX 412A and 412B. Subsequent updates to the remote SoC's VW_RX signal 414 may be updated on every state transition (0->1 or 1->0 transition) of the corresponding local SoC's VW_TX signal 416. In pulse mode, a 0->1->0 transition on Local SoCs VW_TX signal 416 may be transmitted to the remote SoC's VW_RX signal 414.

Different waveforms may be generated on VW_RX. For waveforms that are a pulse, the pulse width may be a single clock cycle of the Chip Link RX clock. If a longer pulse is needed, then additional hardware outside of Chip Link may be added to extend the pulse. In some examples, tight timing (<1 us signal transitions) of virtual wires may not be maintained since other sources of Chip Link traffic may cause congestion when running in parallel to Virtual Wire. To reduce latency due to congestion on the link, virtual wire may have the highest priority (LL-TC1 priority) when messages are sent. The target latency between Local SoC's VW_TX transition and Remote SoC's VW_RX transition may be one microsecond or less to limit skew for time synchronization usage.

VW_RX may also be used to output the behavior of the remote SoC's VW_TX when a local VW_TX is mapped to a local VW_RX and a remote VW_RX. The local VW_RX may only be updated when the virtual wire message is transmitted on the power controller.

Virtual Wire may have a configurable number of VW_TX and VW_RX signals. Chip Link TX may have inputs for VW_TX and Chip Link RX may have outputs for VW_RX which connect to local logic. In systems with multiple SoCs connected through Chip Link, virtual wire may utilize the routing layer message broadcast feature to send messages to all SoCs. There may also be LTLs settings for each wire which may be set in Chip Link TX settings. If a Virtual Wire message fails to be received (e.g., due to fatal error when sending over Chip Link) on a remote SoC, then a fatal error may be reported back to a local SoC and an interrupt may be triggered to signal that an error occurred. In such a case, the initiating logic may toggle the wire again and software may read the status of virtual wires from Chip Link RX. This software may initiate virtual wire toggles through registers in Chip Link TX for testing purposes. For time synchronization purposes, VW_TX [0] may always be mapped to VW_RX [0] in a local SoC. On initial startup on first transition to Active link state, all enabled virtual wires may be sent to the remote SoC to provide the current state of the wires to the remote side. Before this happens, VW_RX may drive a default value of 0.

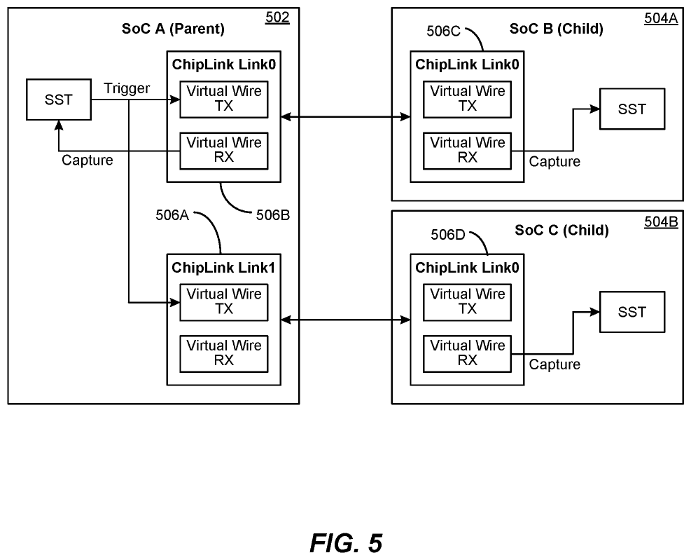

Referring to FIG. 5, time synchronization may be a specific usage of virtual wire messages to sync the System Synchronization Timer (SST) on different SoCs 502, 504A, and 504B. The main role that Chip Link may play in SST time synchronization may be to reduce the amount of skew it takes for a trigger on a Parent SoC 502 to initiate an SST capture on child SoCs 504A and 504B. Before a Time Sync is initiated, the Chip Link links 506A, 506B, 506C, and 506D may be woken up and in an active state to reduce the skew when a parent issues the trigger. Target latency for a trigger to capture on another SoC may be microsecond latency or less. For SoCs that have multiple Chip Link links, all links may be woken up to reduce latency for sending the trigger to all child SoCs. Firmware may be expected to wake all the links before initiating a trigger, and Chip Link hardware may ensure that a capture asserts to a local SST only when Chip Link TX has transmitted virtual wire messages to other SoCs through the local VW_RX signal. Any SoC may be the parent (e.g., trigger) of the virtual wire and systems may be enabled to allow any SoC to be the parent.

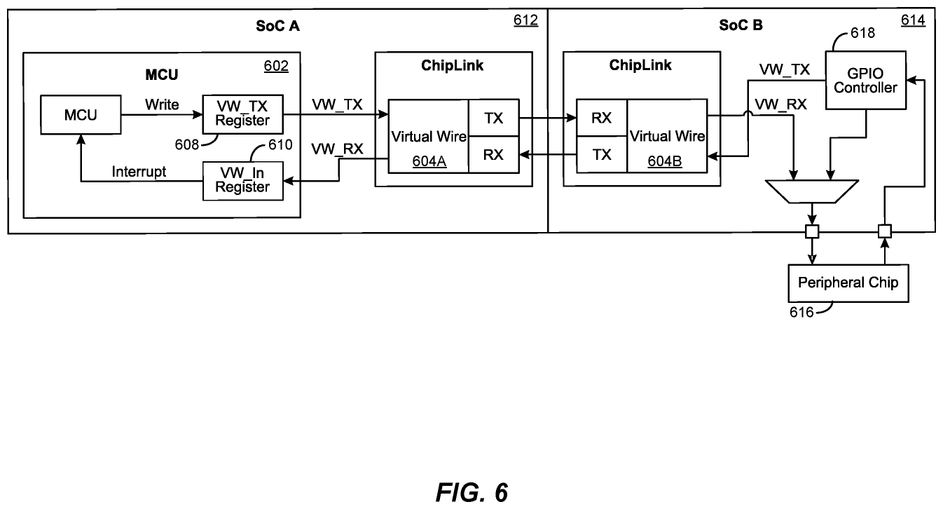

Referring to FIG. 6, for GPIO control through virtual wire, MCUs 602 may implement their own register and logic to connect to the Chip Link virtual wire 604A and 604B. VW_TX and VW_RX registers 608 and 610 may be implemented within the MCU 602 subsystem and connect to Chip Link in SoC A 612. The VW_RX register 610 may be connected to MCU's 602 interrupt vector to allow a peripheral chip 616 connected to SoC B 614 to directly interrupt an MCU 602 on SoC A 612. To clear the interrupt, the VW_RX register 610 in the MCU 602 subsystem may implement appropriate logic. For edge-triggered interrupts, it may be cleared in the local SoC 612 and level interrupts may involve sending an IPC message to the remote SoC 614 to clear the interrupt.

As shown in FIG. 6, GPIOs 618 may also be tunneled from SoC A 612 to SoC B 614. There may be some considerations when performing such tunneling. For example, Chip Link may be off in SoC standby state and therefore the GPIO chosen to be tunneled or used may also be wake capable if the GPIO usage is required to wake from standby states. Latency may vary between microsecond to milliseconds depending on the power state of the SoC and Chip Link. The default value of output GPIO from Chip Link may be zero after Chip Link is brought out of reset. After Chip Link initializes and virtual wire messages are sent between SoCs, then the state of output GPIO may be consistent to input that is generated from the other SoC. In some examples, a set of common virtual wires may be used the same way in all SoCs in a Chip Link network.

Power management may be accomplished by link power states and duty cycle. For example, and in reference to link power states, a Chip Link link may generally operate in two different power modes: active and hibernate states. Messages may flow between peer SoCs in the active state and the hibernate state may correspond to the lowest power state. Portions of Chip Link may be kept always-on to support in-band wakes and queue messages when the link transitions to an active state. The active state may be set to various power modes. Transitioning between different active states may depend on the speed of the link (e.g., 10 us in HS-G4 and 1 ms+ in PWM-G1).

An active to hibernate transition may have a considerable effect on the latency of roundtrip data flows. A message that requires an immediate response from the peer SoC may see a link transition to hibernate and back to active, causing ˜110 us of additional latency (e.g., assuming the response message has level 0 LTL). To allow tuning for these types of data flows, there may be several knobs to control when an Active to Hibernate Transition occurs. Hibernate transition may be requested after a programmable time period after there are no messages to transmit to the remote SoC. The programmable time period may be zero, causing an immediate request for hibernate when the link is idle. Hibernate transition also may be requested after a minimum time period. Once the minimum time period expires, the link may request hibernate when there are no more messages to transmit. A FW initiated hibernate transition may also be implemented. For example, FW on local and peer SoCs may first quiesce Chip Link transmit and then initiate a hibernate transition request. All of these controls may include Chip Link being quiesced and prevented from transmitting messages before entering hibernate state.

Referring to FIG. 7, Chip Link may be duty-cycled such that transactions flow between SoCs through Chip Link at a system specified rate. This may be more energy efficient by aligning transactions in time so that transfers are blocks of data that amortize the cost of transitioning the MPHY from the lowest power state (H8-ULP) to a high-speed state (HS-G3/HS-G4) on the MPHY. A potential downside may be a higher latency for transfers. The system duty cycle rate 702 may be chosen to prevent any long latency for messages. Chip Link may also operate in a mode in which the duty cycle may be turned off and the link may immediately send transactions.

Some power modes may abstract the MPHY power state handling of the MPHY and the application layer requests. Some power modes may put both the controller 704 and the MPHY 706 in the desired power state. When the application layer wakes up a Chip Link link, the Application layer may request fast mode 708A and 708B. After all transactions have been sent, the application layer may request hibernate mode 710. When duty cycling is disabled, the power mode used for communication may be fast auto mode in which the hardware may autonomously switch into a sleep state opportunistically when the link is idle. Fast auto mode may be used when the SoC is in an active state 712A and 712B and hibernate when the SoC is in standby power state.

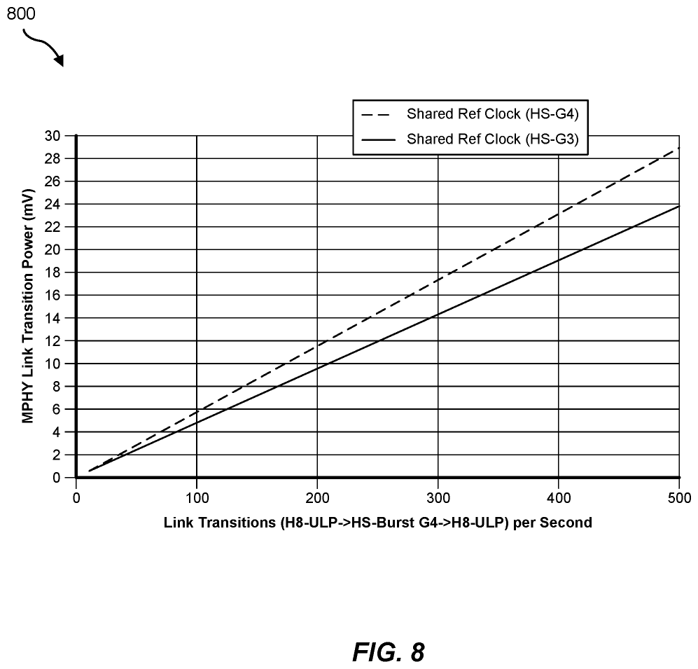

Referring to FIG. 8, the duty cycle period may be programmable and, when combined with latency tolerance levels, may be dynamic and may change depending on a message traffic profile. FIG. 8 shows an example power cost 800 of transitioning a single Chip Link connection (2×MPHY) with duty cycle. The transition power used in this example analysis may correspond to HS-STALL power. The graphed lines show power with different hibernate exit latencies. The message traffic pattern may be optimized with the link transition power cost 800 in mind.

Some power modules may abstract the MPHY power state handling of the MPHY and the application layer may request power modes to put both the controller and the MPHY in the desired power state. FW may have the ability to set which power mode is used for the active and hibernate states. When the application layer wakes up a Chip Link link, the application layer may request fast mode. After all transactions have been sent, the application layer may request hibernate mode. When duty cycling is disabled, the power mode used for communications may be fast auto mode in which the hardware may autonomously switch into a stall state opportunistically when the link is idle. Fast auto mode may be used when the SoC is in an active state and hibernate when the SoC is in standby power state. The Chip Link application layer may also be configured for a fixed active-duty cycle window in which the hardware may wait a configurable amount of time in active state before entering hibernate state. This may mainly be used as a debug function and FW users may not be encouraged to use this option.

In addition to duty cycle waking Chip Link from hibernate state, there may be other methods to wake-up Chip Link from hibernate state. For example, register bits may be available for software to wake Chip Link application layer and Chip Link links. Also, for SoCs with multiple Chip Link links, there may be configuration bits to allow a peer initiated wake to trigger the wake of another link. This functionality may be used to parallelize link wake-up latency when a peer SoC initiates a wake to an SoC with multiple Chip Link links. In addition, messages with LTL0 may trigger a wake of all links in a Chip Link network.

Whenever Chip Link enters the active link state, an indication may be driven from the Chip Link controller for SoC usage, which may be treated as a level interrupt. Such an active indication may be driven high when Chip Link is in an active state and low when Chip Link is in a hibernate state.

Latency Tolerance Levels (LTL) may define a maximum latency a message can tolerate. Latency may start when a message is enqueued in the Chip Link application layer and end when the message is sent to a remote SoC. Chip Link may use LTL to ensure that the link will wake and send the message on or before the LTL selected period of time for that message. LTLs may be completely programmable except for Level 0, which may cause an immediate wake of the link. Level 1 and Level 2 (and subsequent Levels if added) may have increasing latency (e.g., the higher the level, the higher the latency). Level 1 may specify how often the Chip Link Application Layer wakes to check if there are any messages to send. The timings for each level may be driven by SST triggers. All SoCs may have a synchronized SST timer and may perform message checks synchronously.

In an illustrative example, a first LTL (level 0), a second LTL (level 1), and a third LTL (level 2) may be implemented. In this example, level 0 may cause link to wake immediately (e.g., link wake latency ^{˜}100uS for a single link). Also, level 1 may indicate a maximum latency of 1 mS/1000 Hz. Additionally, level 2 may indicate a maximum latency of 4 mS/250 Hz.

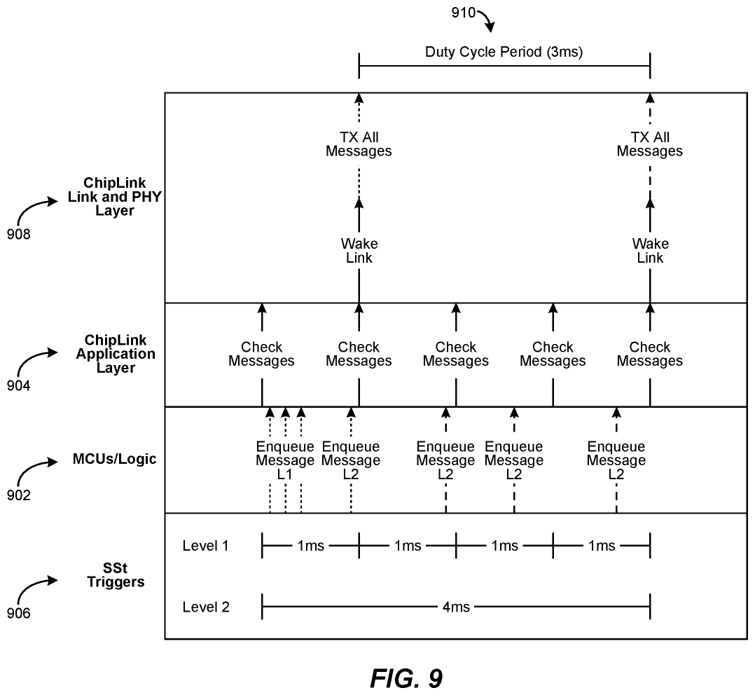

FIG. 9 illustrates an example using the previously stated timings of when messages are sent based on LTL. As shown in FIG. 9, MCUs/Logic 902 may enqueue messages in the Chip Link application layer 904 asynchronously to the SST timing triggers 906. Additionally, local MCUs/Logic 902 may enqueue their messages in the Chip Link application layer 904. Also, IPC messages may be queued in SMEM until allocated space is full, then further transmit requests that may be back pressured until Chip Link is opened to allow transfers. Along with back pressure, an interrupt to the producer MCU may be generated when a queue is full. Remote access and virtual wire may accept transactions in their queues and, when full, may back pressure by not accepting more transactions.

As shown in FIG. 9, the Chip Link application layer 904 may check messages without waking the link. This means that the SST layer 906 and Chip Link application layer 908 (e.g., some portion) may be on when the link is in the hibernate state. When the link wakes, all messages may be sent no matter the LTL. Data may be sent and received simultaneously (i.e., full duplex) after a link is woken up. The Duty Cycle Period 910 may adapt to the message traffic LTL setting and, thus, may not be a constant value. Use of Level 0 and Level 1 may be minimized to reduce the number of link transitions and to save power.

Regarding Chip Link power states, when the SoC is in the active state, Chip Link may transition between active and hibernate based on duty cycle or software-initiated trigger. When the SoC transitions into a standby state, Chip Link may be turned off completely and may be cold booted (e.g., reload MPHY FW and IPC/VW configuration). When Chip Link is off, in-band wakes may not be supported and an out of band wake may be used to wake connected SoCs (e.g., GPIO).

As set forth above, the disclosed systems and methods may queue a message in a message queue based on a latency tolerance level for the message, transition a data transfer link to an active state based on a presence of the message in the message queue and the latency tolerance level for the message, and transfer the message over the data transfer link while the data transfer link is in the active state. In this way, the disclosed systems and methods may duty cycle a link layer of a communication protocol with a frequency that satisfies the latency tolerance level. As a result, the disclosed systems and methods may achieve reduced power consumption and utilize a minimum number of wires to provide a low latency communications channel between packages.

### EXAMPLE EMBODIMENTS

Example 1: A computer-implemented method comprising: queueing, by an integrated circuit, a message in a message queue based on a latency tolerance level for the message; transitioning, by the integrated circuit, a data transfer link to an active state based on a presence of the message in the message queue and the latency tolerance level for the message; and transferring, by the integrated circuit, the message over the data transfer link while the data transfer link is in the active state.

Example 2: the method of example 1, wherein queueing the message includes determining the latency tolerance level for the message by: determining a message type of the message; and identifying a predefined latency tolerance level associated with the message type.

Example 3: The method of example 1 or 2, wherein queueing the message includes: queueing a first message having a first latency tolerance level in a first message queue dedicated to messages having the first latency tolerance level; and queueing a second message having a second latency tolerance level in a second message queue that is dedicated to messages having the second latency tolerance level.

Example 4: The method of any of examples 1-3, wherein transitioning the data transfer link includes: observing, at a first point in time, absence of at least one message having a first latency tolerance level; and waiting, in response to the observation, until a second point in time to observe presence of at least one message having a second latency tolerance level, wherein the transition of the data transfer link to the active state occurs in response to the presence of the at least one message having the second latency tolerance level.

Example 5: The method of any of examples 1-4, wherein transferring the message over the data transfer link includes: transferring a plurality of messages having different latency tolerance levels over the data transfer link.

Example 6: The method of any of examples 1-5, wherein the message is generated by a first system on a chip (SoC) and is transferred to a second SoC.

Example 7: The method of any of examples 1-6, further comprising: utilizing a virtual wire comprising a physical wire to virtual wire message interface to perform two-way transfer of messages between a first system on a chip (SoC) and a second SoC.

Example 8: A system comprising: at least one physical processor; and physical memory comprising computer-executable instructions that, when executed by the at least one physical processor, cause the at least one physical processor to: queue a message in a message queue based on a latency tolerance level for the message; transition a data transfer link to an active state based on a presence of the message in the message queue and the latency tolerance level for the message; and transfer the message over the data transfer link while the data transfer link is in the active state.

Example 9: The system of example 8, wherein the computer-executable instructions cause the at least one physical processor to queue the message by determining the latency tolerance level for the message by: determining a message type of the message; and identifying a predefined latency tolerance level associated with the message type.

Example 10: The system of example 8 or 9, wherein the computer-executable instructions cause the at least one physical processor to queue the message at least in part by: queueing a first message having a first latency tolerance level in a first message queue dedicated to messages having the first latency tolerance level; and queueing a second message having a second latency tolerance level in a second message queue that is dedicated to messages having the second latency tolerance level.

Example 11: The system of any of examples 8-10, wherein the computer-executable instructions cause the at least one physical processor to transition the data transfer link at least in part by: observing, at a first point in time, absence of at least one message having a first latency tolerance level; and waiting, in response to the observation, until a second point in time to observe presence of at least one message having a second latency tolerance level, wherein the transition of the data transfer link to the active state occurs in response to the presence of the at least one message having the second latency tolerance level.

Example 12: The system of any of examples 8-11, wherein the computer-executable instructions cause the at least one physical processor to transfer the message over the data transfer link at least in part by: transferring a plurality of messages having different latency tolerance levels over the data transfer link.

Example 13: The system of any of examples 8-12, wherein the message is generated by a first system on a chip (SoC) and is transferred to a second SoC.

Example 14: The system of any of examples 8-13, wherein the computer-executable instructions cause the at least one physical processor to: utilize a virtual wire comprising a physical wire to virtual wire message interface to perform two-way transfer of messages between a first system on a chip (SoC) and a second SoC.

Example 15: A method comprising: identifying, by an integrated circuit and at an application layer of a communication protocol, a latency tolerance level; and duty cycling, by the integrated circuit, a link layer of the communication protocol with a frequency that satisfies the latency tolerance level.

Example 16: The method of example 15, wherein determining the latency tolerance level includes: determining a message type of a message; and identifying a predefined latency tolerance level associated with the message type.

Example 17: The method of example 15 or 16, wherein duty cycling the link layer includes: transitioning a data transfer link to an active state based at least in part on the latency tolerance level.

Example 18: The method of any of examples 15-17, wherein duty cycling the link layer includes: transitioning a data transfer link to a low-power state following transfer of messages by the link layer.

Example 19: The method of any of examples 15-18, wherein the link layer utilizes a virtual wire comprising a physical wire to virtual wire message interface to perform two-way transfer of messages between a first system on a chip (SoC) and a second SoC.

Example 20: The method of any of examples 15-19, wherein the link layer transfers all enqueued messages while in an active state regardless of latency tolerance levels of the enqueued messages.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality-systems may be designed to work without near-eye displays (NEDs). Other artificial-reality systems may include an NED that also provides visibility into the real world (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015 (A) and a right display device 1015 (B) in front of a user's eyes. Display devices 1015 (A) and 1015 (B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(I) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented-reality device 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015 (A) and 1015 (B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(l) and 1020(J)) that are part of the microphone array (or potentially form their own microphone subarray). Neckband 1005 may also include a controller 1025 and a power source 1035.

Acoustic transducers 1020(I) and 1020(J) of neckband 1005 may be configured to detect sound and convert the detected sound into an electronic format (analog or digital). In the embodiment of FIG. 10, acoustic transducers 1020(l) and 1020(J) may be positioned on neckband 1005, thereby increasing the distance between the neckband acoustic transducers 1020(I) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium-ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106 (A) and 1106 (B). Furthermore, while not shown in FIG. 11, front rigid body 1102 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A computer-implemented method comprising:
queueing, by an integrated circuit, a message in a message queue based on a latency tolerance level for the message;
transitioning, by the integrated circuit, a data transfer link to an active state based on a presence of the message in the message queue and the latency tolerance level for the message; and
transferring, by the integrated circuit, the message over the data transfer link while the data transfer link is in the active state.

2. The computer-implemented method of claim 1, wherein queueing the message includes determining the latency tolerance level for the message by:
determining a message type of the message; and
identifying a predefined latency tolerance level associated with the message type.

3. The computer-implemented method of claim 1, wherein queueing the message includes:
queueing a first message having a first latency tolerance level in a first message queue dedicated to messages having the first latency tolerance level; and
queueing a second message having a second latency tolerance level in a second message queue that is dedicated to messages having the second latency tolerance level.

4. The computer-implemented method of claim 1, wherein transitioning the data transfer link includes:
observing, at a first point in time, absence of at least one message having a first latency tolerance level; and
waiting, in response to the observation, until a second point in time to observe presence of at least one message having a second latency tolerance level,
wherein the transition of the data transfer link to the active state occurs in response to the presence of the at least one message having the second latency tolerance level.

5. The computer-implemented method of claim 1, wherein transferring the message over the data transfer link includes:
transferring a plurality of messages having different latency tolerance levels over the data transfer link.

6. The computer-implemented method of claim 1, wherein the message is generated by a first system on a chip (SoC) and is transferred to a second SoC.

7. The computer-implemented method of claim 1, further comprising:
utilizing a virtual wire comprising a physical wire to virtual wire message interface to perform two-way transfer of messages between a first system on a chip (SoC) and a second SoC.

8. A system comprising:
at least one physical processor; and
physical memory comprising computer-executable instructions that, when executed by the at least one physical processor, cause the at least one physical processor to:
queue a message in a message queue based on a latency tolerance level for the message;
transition a data transfer link to an active state based on a presence of the message in the message queue and the latency tolerance level for the message; and
transfer the message over the data transfer link while the data transfer link is in the active state.

9. The system of claim 8, wherein the computer-executable instructions cause the at least one physical processor to queue the message by determining the latency tolerance level for the message by:
determining a message type of the message; and
identifying a predefined latency tolerance level associated with the message type.

10. The system of claim 8, wherein the computer-executable instructions cause the at least one physical processor to queue the message at least in part by:
queueing a first message having a first latency tolerance level in a first message queue dedicated to messages having the first latency tolerance level; and
queueing a second message having a second latency tolerance level in a second message queue that is dedicated to messages having the second latency tolerance level.

11. The system of claim 8, wherein the computer-executable instructions cause the at least one physical processor to transition the data transfer link at least in part by:
observing, at a first point in time, absence of at least one message having a first latency tolerance level; and
waiting, in response to the observation, until a second point in time to observe presence of at least one message having a second latency tolerance level,
wherein the transition of the data transfer link to the active state occurs in response to the presence of the at least one message having the second latency tolerance level.

12. The system of claim 8, wherein the computer-executable instructions cause the at least one physical processor to transfer the message over the data transfer link at least in part by:
transferring a plurality of messages having different latency tolerance levels over the data transfer link.

13. The system of claim 8, wherein the message is generated by a first system on a chip (SoC) and is transferred to a second SoC.

14. The system of claim 8, wherein the computer-executable instructions cause the at least one physical processor to:
utilize a virtual wire comprising a physical wire to virtual wire message interface to perform two-way transfer of messages between a first system on a chip (SoC) and a second SoC.

15. A method comprising:
identifying, by an integrated circuit and at an application layer of a communication protocol, a latency tolerance level; and
duty cycling, by the integrated circuit, a link layer of the communication protocol with a frequency that satisfies the latency tolerance level.

16. The method of claim 15, wherein determining the latency tolerance level includes:
determining a message type of a message; and
identifying a predefined latency tolerance level associated with the message type.

17. The method of claim 15, wherein duty cycling the link layer includes:
transitioning a data transfer link to an active state based at least in part on the latency tolerance level.

18. The method of claim 15, wherein duty cycling the link layer includes:
transitioning a data transfer link to a low-power state following transfer of messages by the link layer.

19. The method of claim 15, wherein the link layer utilizes a virtual wire comprising a physical wire to virtual wire message interface to perform two-way transfer of messages between a first system on a chip (SoC) and a second SoC.

20. The method of claim 15, wherein the link layer transfers all enqueued messages while in an active state regardless of latency tolerance levels of the enqueued messages.
